(19) United States
(12) Patent Application Publication
(10) Pub. No.: US 2008/0006427 A1
(43) Pub. Date: Jan. 10, 2008

(54) Method and System for Testing or Measuring Electrical Elements, Using Two Offset Pulses

(75) Inventors: Christophe Vaucher, Bandol (FR); Pierre Benech, Grenoble (FR)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: BEAMIND, Bandol (FR)

(21) Appl. No.: 11/833,392

(22) Filed: Aug. 3, 2007

Related U.S. Application Data
(63) Continuation of application No. PCT/FR2006/000154, filed on Jan. 24, 2006.

(30) Foreign Application Priority Data
Feb. 4, 2005 (FR) 0501099

(51) Int. Cl. H02G 7/00

(52) U.S. Cl. 174/5 R

(57) ABSTRACT

A method for testing electric elements includes applying a first beam of particles to a first location of an electric element, to liberate electrons from the first location, and applying a second beam of particles to a second location of an electric element, with a temporal shift (Δt) different from zero in relation to the application of the first beam of particles, to liberate electrons from the second location. The temporal shift is on the order of magnitude of a propagation time of electrons between the first and the second location. Electrons liberated under the effect of the first and second beams of particles are collected, and at least one quantity of electric charges corresponding to the collected electrons liberated under the effect of the second beam of particles is measured and quantitatively or qualitatively deducing therefrom an electric feature of the electric element.

### CROSS-REFERENCE TO RELATED APPLICATIONS

This application is a Continuation of International Application No. PCT/FR2006/000154, filed Jan. 24, 2006, which was published in the French language on Aug. 10, 2006, under International Publication No. WO 2006/082293 A1 and the disclosure of which is incorporated herein by reference.

### BACKGROUND OF THE INVENTION

The invention relates to a method and a system for testing or measuring electric elements, in particular electric conductors or groups of electric conductors, electric components.

The invention particularly but not exclusively relates to the test of conducting paths present in interconnection supports.

Interconnection supports are present in the majority of electronic devices and testing them is all the more crucial since their dimensions continuously decrease with the evolution of manufacturing and integration techniques. The test of interconnection support is thus an integral part of their manufacturing process. The interconnection supports are particularly HDI printed circuits (High Density Interconnect) and they are present in the majority of portable electronic devices (cell phones, MP3 players, disks readers/recorders, digital cameras, etc.) and in Integrated Circuit (IC) packages (e.g., microprocessors or memories). The interconnection supports for integrated circuits called “IC package substrates” or “chip carriers” are also concerned. These interconnection supports are very “dense” and can have widths of conductors and pitches between conductors of very low value, for example some tens of micrometers, and contact pads which dimension is lower than a hundred micrometers.

In addition to the conductors present on the aforementioned interconnection supports, various other types of conductors are susceptible to be tested, for example the conductors present in LCD or plasma flat screens, the conductors present in the integrated circuits before encapsulation, and more generally any types of electric components. The test of these conductors or electric components is also an integral part of the manufacturing process of interconnection supports or electronic circuits.

Among the tests conventionally conducted on the interconnection supports, some aim at measuring the continuity, insulation, resistance, capacitance or self-inductance of conductors, or even of components mounted on the supports. The conductors are generally conducting paths distributed on one or more electrically insulating layers of a substrate, and can be linked by metallized holes crossing the substrate (“vias”).

To test these conducting paths, it is known to use measuring systems which mechanically access to their contact pads, when they are physically accessible and when the mechanical contact made during the test operation is not damageable to the integrity of the substrate after the test. However, it becomes impossible to take this measure in a complete way when only one contact pad of the conducting paths is physically accessible and the other pad cannot or must not be touched to avoid damaging it. This is for example the case of the paths of printed circuits of “IC package substrates” type playing the role of spark gap. These circuits make it possible to bring to one pitch of standard printed circuit, i.e., about one millimeter, an electronic component like a semiconductor chip, having a much higher connection density, of about some tens of micrometers.

Other solutions have also been considered according to the state-of-the-art with the view of performing the aforementioned tests, included when one of the contact pads of a path is not physically accessible.

Among these solutions, some suggest a capacitive coupling between an electrode and a conducting path to be tested. However, these solutions require the manufacture of complex and expensive tools. Moreover, they do not allow the resistance of the tested conducting paths to be determined. Eventually, they do not comply with new generations of substrates for chips mounted using the flip-chip technique for which the bumps of solder with the chip are not arranged on the periphery of the substrate but in a matrix way on the surface of the interconnection support.

Other solutions are described in particular by the U.S. Pat. No. 6,369,591 (Cugini et al.) and European Patent Application Publication No. EP-1 236 052 (Vaucher Christophe). These solutions suggest to eject electrons from the printed circuit to be tested by photoelectric effect using a beam of laser light. The ejected electrons are collected thanks to a conducting anode formed by a plate transparent to the incident beam of laser light.

The solution described in U.S. Pat. No. 6,369,591 is a pure contactless solution. However, it has the drawback of not allowing the resistance of the conductors to be quantitatively measured, but only to be qualitatively measured, i.e., to determine if two points of a path are linked by a resistance lower than a few giga-Ohms without measuring the actual value of the resistance. In addition, this method requires to charge/discharge the conducting paths with electrons to allow in particular the measure to be reset. The reset can take a considerable amount of time for the paths of great dimensions, which slows the tests down in a way incompatible with the industrial requirements of productivity.

The solution described in EP 1 236 052 suggests a contactless photoelectric access to contact pads of conductors of small dimensions. The electrons liberated by photoelectric effect are collected by a collector consisting of areas individually addressable to multiple potentials. The circuit is arranged in loop through a measuring system and a source that returns the electrons to the other end of the path. This solution constitutes a significant improvement compared to the aforementioned methods.

The IBM document “Photoelectric Test Method for PCB Conductors” teaches applying pulses of light with a determined temporal shift at two points of a conductor to be tested. The first point receives a pulse of sufficient duration or intensity to modify the electric potential of the conductor at the first point, while the second point receives a pulse the duration or intensity of which is insufficient to modify the electric potential of the conductor at the second point. The conductor to be tested is biased by capacitive effect by means of a buried conductor subject to a difference in potential compared to the collector. Measuring the pulses of current corresponding to the pulses at the second point makes it possible to determine whether or not the conductor has an electrical continuity. If the pulses of current drop in intensity after application of a new pulse of light at the first point, it can be deduced that the potential of the second point has increased under the effect of the pulses and that the conductor has an electrical continuity. This method is thus of the “all or none” type and only makes it possible to find out whether or not an electric element has a continuity or insulation fault, without enabling it to be quantified.

Generally, it is more and more difficult to perform tests compatible with the productivity requirements imposed by the industry, while accessing the values of the resistances of the conducting paths which continuity and insulation are measured. That is the case, in particular, when no contact pad of the paths is mechanically accessible or when there is a risk of damaging the contact pads used as test points.

### BRIEF SUMMARY OF THE INVENTION

Thus, embodiments of the invention are directed to a method and a system for testing or measuring electric elements with which the risks of damaging the elements are minimum, the measures being able to be taken according to rates compatible with the current production requirements.

Embodiments of the invention more particularly are directed to improving the testing or measuring methods based on the ejection of electrons from an element to be tested using a beam of particles applied to the element to be tested, in particular the ejection of electrons by photoelectric effect.

Thus, one embodiment of the present invention comprises a method for testing or measuring electric elements. The method includes applying a first beam of particles to a first location of an electric element, to liberate electrons from the first location, applying a second beam of particles to a second location of an electric element with a temporal shift different from zero compared to the application of the first beam of particles to the first location, to liberate electrons from the second location, collecting electrons liberated under the effect of the application of the first beam of particles to the first location. Electrons liberated under the effect of the application of the second beam of particles to the second location are collected. At least one quantity of electric charges corresponding to the collected electrons liberated under the effect of the application of the second beam of particles to the second location are measured, and an electric feature of the electric element is quantitatively or qualitatively deduced therefrom

According to one embodiment, the temporal shift is of the order of magnitude of a propagation time of electrons between the first and the second locations.

According to one embodiment, the temporal shift is of about one pico-second to a few nano-seconds.

According to one embodiment, the insulation, the continuity, the capacitance and/or the resistance of the electric element is deduced from the comparison of the quantity of electric charges collected under the effect of the application of the first beam of particles to the quantity of electric charges collected under the effect of the application of the second beam of particles.

According to one embodiment, the electric element is an electric conductor or a group of electric conductors, an electric component or an electronic component.

According to one embodiment, the first location is a first pad of an electric conductor and the second location is a second pad of the electric conductor or a pad of another electric conductor.

According to one embodiment, the first and the second beams of particles are beams of ultraviolet light.

According to one embodiment, the first and the second beams of particles result from the division of a same beam of particles.

According to one embodiment, the temporal shift is obtained by making the second beam of particles go on a more significant distance than the distance of the first beam of particles, before the second beam of particles reaches the second location.

According to one embodiment, the electrons liberated under the effect of the application of the first and second beams of particles are collected by a collector taken to an electric potential, and at least the first location is taken to a potential lower than the potential of the collector prior to the application of the first beam of particles to the first location.

According to one embodiment, the electrons liberated under the effect of the application of the first and second beams of particles are collected by a collector taken to an electric potential, the application of the first beam of particles takes the electric element to the potential of the collector and the quantity of electric charges collected under the effect of the application of the second beam of particles is measured.

According to one embodiment, the electrons liberated under the effect of the application of the first and second beams of particles are collected by a collector, and the collector comprises at least a first collecting electrode facing the first location and at least a second collecting electrode facing the second location, both collecting electrodes being distinct and individually accessible to take a local measure of collected electric charge.

Another embodiment of the present invention relates to a method for manufacturing an interconnection support or an electronic circuit arranged on an interconnection support. The interconnection support or the electronic circuit comprising electric elements. The method includes a step of testing or measuring all or part of the electric elements of the interconnection support or of the electronic circuit implemented. The step of testing or measuring all or part of the electric elements of the interconnection support includes applying a first beam of particles to a first location of an electric element, to liberate electrons from the first location; applying a second beam of particles to a second location of an electric element with a temporal shift different from zero compared to the application of the first beam of particles to the first location, to liberate electrons from the second location, the temporal shift being of the order of magnitude of a propagation time of electrons between the first and the second location; collecting electrons liberated under the effect of the application of the first beam of particles to the first location; collecting electrons liberated under the effect of the application of the second beam of particles to the second location; measuring at least one quantity of electric charges corresponding to the collected electrons liberated under the effect of the application of the second beam of particles to the second location, and quantitatively or qualitatively deducing therefrom an electric feature of the electric element.

Another embodiment of the present invention relates to a system for testing or measuring electric elements comprising a device for applying a first beam of particles to a first location of an electric element so as to induce a liberation of electrons from this first location, and applying a second beam of particles to a second location of an electric element so as to induce a liberation of electrons from the second location. The device includes a device for shifting the application of the second beam of particles to the second location compared to the application of the first beam of particles to the first location, with a temporal shift different from zero, at least one collector for collecting electrons liberated under the effect of the application of the first beam of particles and electrons liberated under the effect of the second beam of particles, and a device for measuring at least one quantity of electric charges corresponding to the collected electrons liberated under the effect of the application of the second beam of particles to the second location and quantitatively or qualitatively deducing therefrom an electric feature of the electric element.

According to one embodiment, the temporal shift is of the order of magnitude of a propagation time of electrons between the first and the second locations.

According to one embodiment, the temporal shift is of about one pico-second to a few nano-seconds.

According to one embodiment, the collector comprises at least one first collecting electrode facing the first location and at least one second collecting electrode facing the second location, both collecting electrodes being distinct and individually accessible, and allowing the measuring means to take a local measure of collected electric charge, at least at the second location.

According to one embodiment, the system comprises a device for deducing the continuity, the insulation, the capacitance and/or the resistance of the electric element from a measure of the quantity of electric charges collected under the effect of the application of the first beam of particles and the quantity of electric charges collected under the effect of the application of the second beam of particles.

According to one embodiment, the system is arranged for testing or measuring an electric conductor or a group of electric conductors, an electric component or an electronic component.

According to one embodiment, the system comprises a device for dividing a beam of particles in order to form the first and the second beams of particles.

According to one embodiment, the system comprises a device for having the second beam of particles go on a more significant distance than the distance of the first beam of particles, before the second beam of particles reaches the second location of the electric element.

According to one embodiment, the first and second beams of particles are beams of ultraviolet light.

According to one embodiment, the system comprises a beam splitter fitted with holes arranged between the substrate and the collector, the holes forming flow channels for electrons.

According to one embodiment, the system comprises a collector comprising several electrodes and means for taking electrodes to a repulsive potential in order to form flow channels for electrons.

### BRIEF DESCRIPTION OF THE SEVERAL VIEWS OF THE DRAWINGS

The foregoing summary, as well as the following detailed description of embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 schematically shows the method and system according to one embodiment of the invention applied to the measure of the electric continuity of a conductor;

FIG. 2A is the equivalent diagram of a system according to one embodiment of the invention, during the application of a first beam of particles to the conductor;

FIG. 2B is the equivalent diagram of a system according to one embodiment of the invention, during the application of a second beam of particles to the conductor;

FIG. 3 shows the variations of collected electric charges according to the resistance of the conductor;

FIGS. 4A and 4B show the evolution with time of collected electric charges and electric potentials present on test points, for a first value of resistance of the conductor, and

FIGS. 5A and 5B show the evolution with time of collected electric charges and electric potentials present on test points, for a second value of resistance of the conductor.

### DETAILED DESCRIPTION OF THE INVENTION

A method and system according to one embodiment of the invention are used to test or measure an electric feature of an electric element, like the continuity, the insulation, the capacitance and/or the resistance of a conductor or a conducting path, arranged on an insulating substrate. This substrate can have conducting paths arranged on one or more dielectric layers and form for example a very high density printed circuit of “HDI” type.

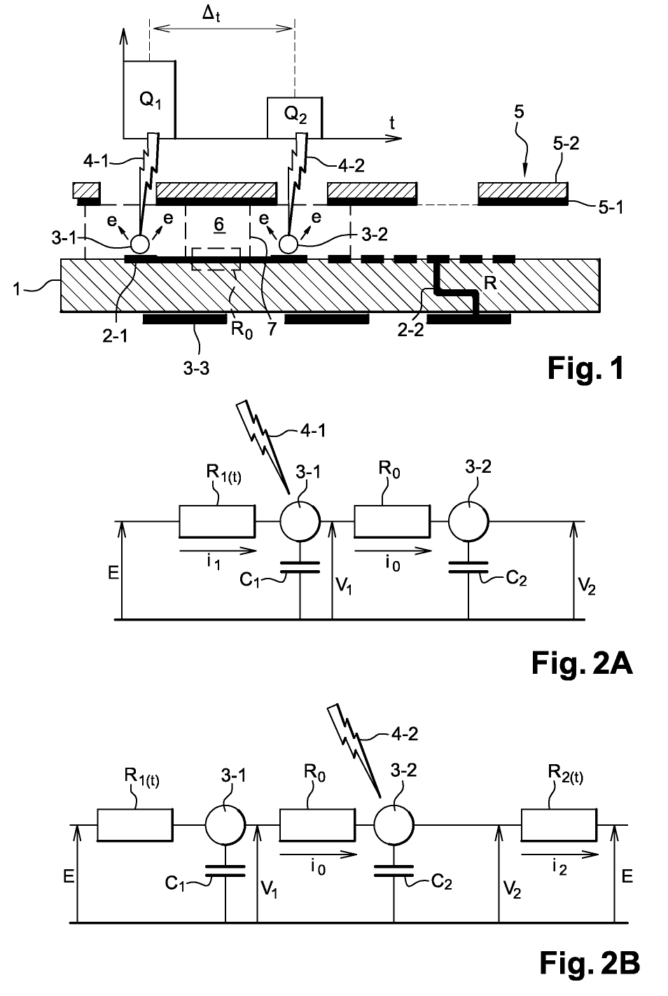

In FIG. 1, a circuit to be tested, shown as a non-limitative example, is a “chip carrier” interconnection support of spark gap type, allowing an electronic component of semiconductor chip type, having a much higher connection density, to be brought to one pitch of standard printed circuit, about one millimetre. This circuit comprises conducting paths arranged on an insulating substrate 1, subjected to measures according to one embodiment of the invention. Here, they are conducting paths of low capacitance, typically a few tens of femto-Farads (fF) to a few pico-Farads (pF). It is worth noting that these values are relative and depend on the distance between the interconnection support to be tested and a collector 5 described below in further detail. It is thus possible to increase the distance between the collector 5 and the conducting paths in order to take measures for paths of higher capacitance, and conversely.

More particularly, the interconnection support comprises conducting paths 2-1 arranged on the upper face of the substrate 1, paths arranged on the lower face of the substrate, and paths 2-2 crossing the substrate (paths comprising “vias”). Each path generally comprises a contact pad, located on the upper face or on the lower face of the substrate. Here, pads 3-1, 3-2 are located on the upper face of the substrate and allow for example a chip to be mounted using the “flip-chip” technique. The pads 3-1, 3-2 are here of “Controlled Collapsed Chip Connection” type (C4) and are covered with a stain metallic alloy containing lead or not. Other pads 3-3 (only one of them being shown) are located on the lower face of the substrate, and are here of “Ball Grid Array” type (BGA). The pads of C4 type, like the pads of BGA type, form interconnection contacts arranged under matrix form on the surface of the substrate 1. Thus, a conducting path can be here of C4 to C4 type and link two or more pads of C4 type on the upper face of the substrate, or of the BGA to BGA type and link two pads of BGA type on the lower face of the substrate, or of the C4 to BGA type and link at least one pad of C4 type to at least one pad of BGA type (crossing paths).

In the example of FIG. 1, the conducting path 2-1 on the upper face of the substrate is subjected to a test or a measure according to the method of the invention. The path is of C4-C4 type and links the pads 3-1 and 3-2 which are located at its two ends. The path has a serial resistance R₀ between the pads 3-1 and 3-2. The pads 3-1, 3-2 are used as test points of the path 2-1.

The system comprises a device for generating a first 4-1 and a second 4-2 beams of particles. The beam of particles 4-1 is applied to a first location of the conducting path, here the pad 3-1, whereas the beam of particles 4-2 is applied to a second location of the path, here the pad 3-2, here in order to conduct a continuity test. However, the beam 4-2 can also be applied to a location chosen on another path of the same substrate, for example to perform an insulation test between two paths.

The beam 4-1 is able to liberate electrons from the first location of the path 2-1 and the beam 4-2 is able to liberate electrons from the second location of the path 2-1. To that end, the beams 4-1, 4-2 can be beams of photons or beams of particles like electrons or ions. In the example described here, the beams are beam of laser light which wavelength, chosen within the range of ultraviolets, is short enough to allow electrons to be ejected from the material constituting the path or the pad by photoelectric effect. Typically, the required wavelength ranges from 200 to 300 nm according to metals or alloys. The laser source used is advantageously of pulsed type, and is for example a YAG laser source multiplied in frequency according to a factor five. The duration of a pulse of laser light (duration of a photoelectric shot) is preferably about a few nano-seconds (ns).

It is worth noting that if beams of electron are used rather than beams of photon, their incident energy must be such that the number of secondary electrons emitted by the target material shot is greater than the number of absorbed electrons, in order to create a current between the target areas and the collector 5, which is well known per se from those skilled in the art.

According to one embodiment of the invention, the application of the beam 4-1 to the pad 3-1 and the application of the beam 4-2 to the pad 3-2 are separated by a temporal shift Δt that can be adjustable, particularly in relation with the type of measure which must be taken. The shift Δt is of short duration. More precisely, the shift is of the order of magnitude of the propagation time of electrons between two measuring points (target areas, here the pads 3-1, 3-2) and is preferably inferior to this propagation time. This propagation time is defined by the RC time constant of the conducting path between the measuring points (for a continuity measure) or by the RC time constant between two measuring points located on two different conducting paths (for an insulation measure). Given the material constraints of implementation to obtain a temporal shift inferior to one pico-second, this temporal shift will be in practice chosen in a range of values going from one pico-second to a few nanoseconds.

The beams of light 4-1, 4-2 can come from a same pulsed beam of laser light, dividing it into two parts using to a beam splitter. The setting of the temporal shift Δt can be obtained by making the second beam travel along an optical path longer than that of the first beam, for example between several mirrors. The resulting modification of the optical path introduces a delay corresponding to the desired shift Δt. In the air, this delay is about 3 ns per meter of difference between the optical paths. Given that it is possible to set a length of optical path to within about a few micrometers, the precision regarding the temporal shift between the beams is about a few femtoseconds (fs). In free space, 1 ns corresponds to a difference of optical path of 30 cm and 1 fs thus corresponds to a difference of optical path of 0.3 μm. A difference of about one fs is thus hardly conceivable. However, a difference of about one picosecond (ps), corresponding to about 300 μm of difference of optical path, can be practically implemented.

The temporal shift Δt between the two beams of light can also be obtained by inserting in the optical path of the second beam a material having an optical index superior to the material forming the optical path of the first beam.

The collector 5 is arranged above the substrate 1 and preferably parallel to it, and thus interposes between the beams of light 4-1, 4-2 and the substrate. The collector comprises a region of collecting electrode 5-1 comprising openings for the beams of light 4-1, 4-2 to pass through them, and may comprise a support plate 5-2, transparent or partially transparent to beams of light, on which the region of collecting electrode 5-1 is arranged. The collector 5 is used to collect the electrons liberated by the beam of light 4-1 and the electrons liberated by the beam of light 4-2, and is taken to a positive electric potential Vc to that purpose by a voltage generator (not shown).

For greater convenience of language, the terms “quantity of charges” or “quantity of electricity” will be hereinafter considered as synonyms, to designate a quantity of electric charges collected using the collector 5 after applying to the conducting path 2-1 a shot of laser light. Thus, the same reference Q₁ applies to the collected quantity of charges after applying the beam of light 4-1 and to the corresponding quantity of measured electricity, and the same reference Q₂ applies to the collected quantity of charges by the collector after applying the beam of light 4-2 and to the corresponding quantity of measured electricity.

Likewise, in accordance with the usual technical language, “charge of a path” or “charge of a capacitance” refers to the fact of increasing the electric potential of the path or the capacitance, this charge corresponding to a loss of electrons.

Two variations of the method of the invention which are only examples of implementation of the invention are now going to be described.

According to the first variation, the region of collecting electrode 5-1 of the collector 5 is formed by a single collecting electrode used to collect electrons coming from any point of the path and particularly the electrons ejected from one or the other contact pad used here as test points and forming photoelectric impact areas.

The electrons going around between the photoelectric impact areas and the collector 5 are channelled by an electrically insulating beam splitter 6, interposed between the collector 5 and the substrate 1, fitted with holes 7 crossing right through it and forming channels for the flow of electrons.

During a preliminary step, the path is taken to a determined electric potential, inferior to the potential Vc of the collector 5. In practice, the difference of potential between the collector and the conducting path can be set to values ranging from a few hundreds of mV to a few tens of Volts.

The first beam 4-1 is then applied to the pad 3-1 and causes the ejection of electrons by photoelectric effect. The duration of the application of the beam 4-1 is set so that the pad 3-1 is immediately charged to the potential Vc of the collector.

The second beam 4-2 is then applied to the pad 3-2, with the temporal shift Δt, and the quantity of charges Q₂ collected by the collector is measured and is compared to a threshold Qt corresponding to a predetermined resistance threshold Rt beyond which the path is considered as faulty. The relation between the threshold Qt and the threshold Rt is determined by calibration, for a given temporal shift Δt.

Thus the measurement variations can be described as follows:

(i) if the quantity of electricity Q₂ is equal to zero, it means that no electron has been collected and that the pad 3-2 is already at the potential Vc of the collector 5 or very near to it. In other words, the electrons have had the time to propagate from the pad 3-2 to the pad 3-1 through the resistor R₀, during the time interval Δt between the starts of each shot. It is deduced therefrom that the path has a low resistance value R₀ inferior to the threshold Rt.

(ii) if the quantity of electricity Q₂ is inferior to the threshold Qt, it means that a few electrons have been collected, that the pad 3-2 is near the potential Vc and that the path has a resistance value R₀ inferior to the threshold Rt.

(iii) if the quantity of electricity Q₂ is superior to the threshold Qt, it means that the potential of the pad 3-2 is quite far from the electric potential Vc and that the resistance R₀ is superior to the threshold Rt, the path therefore being considered as faulty.

This first variation of the invention thus allows a qualitative test of “pass or fail” type (“good” or “bad” path) to be conducted without measuring the resistance R₀.

It is desirable to conduct a qualitative test, that is a measure of the resistance R₀, it is necessary to measure Q₁ for reasons that will be presented below.

The first variation of the invention which has just been described does not easily lend itself to a measure of Q1, because measuring with a same collecting electrode the two quantities of electricity Q₁, Q₂ transferred in the very short time interval Δt requires the provision of an electronic circuit measuring quickly and consequently expensive to manufacture. In addition, the duration of the laser pulse (shot duration), about one nanosecond, can be a limit to the measure when Δt is inferior to the shot duration (which implies an overlap of the shots) except if the first pad is taken to the potential Vc of the collector 5 within the very first part of the pulse.

The second variation of the invention makes the measure of the quantity of electricity Q1 easier and thus allows a qualitative test (without measuring Q₁) or a quantitative test (measuring Q₁) to be indiscriminately conducted.

The second variation is based on the use of a collector 5 which region of collecting electrode 5-1 comprises several distinct individually addressable electrodes (the beams of laser light here crossing the existing spaces between the electrodes). The electrodes facing the photoelectric impact areas are taken to the positive potential Vc.

The electrons going around between the target areas and the collector can be channelled, as previously, by the beam splitter 6 interposed between the collector 5 and the substrate 1. However, here, the electrons can also be channelled with “guard rings” as described by EP 1 236 052, formed by a repulsive electric field which is obtained by taking to a repulsive electric potential electrodes of the collector located near the photoelectric impact areas.

The collector 5 thus comprises at least two addressing networks of its electrodes, each network being connected to a measuring system which is allotted thereto for the measure of the quantities of electricity Q₁, Q₂, while being connected to a source of voltage supplying the potential Vc to the collecting electrodes. A third network can be provided for the application of the repulsive potential to the neighbouring electrodes, if it is not wished to use the beam splitter 6.

In addition, a beam of laser light which is divided into two substantially equal parts 4-1, 4-2, as suggested above, is preferably used here. Both beams 4-1, 4-2 are preferably rigorously synchronous and have an identical pulse profile.

Due to the beam splitter 6 or the guard rings, the electrons emitted by photoelectric effect are forced to move around in a limited space, so that they are all collected by the area of the collector located vertically to the pad to be measured, which can comprise one or more collecting electrodes according to its dimensions.

Conversely to the first variation, it is therefore not necessary to charge the path 2-1 in one laser shot. It is not necessary either—although possible—to totally charge this path after the two shots (that is to take it to the potential Vc of the collector).

In addition, the quantities of charges corresponding to the number of electrons ejected from the contact pads 3-1, 3-2 are measured by the aforementioned measuring systems, each measuring system having an independent access to the electrodes of the collector 5.

The difference ΔQ between the collected quantities of charges Q₁, Q₂ mainly depends on four parameters. First, it depends on the difference of transmission of the beams through the collector, this difference particularly resulting from the fact that there is a difference between the respective energy of each sub-beam actually crossing the collector in two different locations. In practice, the effect of this difference of transmission on the collected quantities of charges should be about a few percents maximum. It also depends on the delay of the second beam in relation to the first. Indeed, pumping the electrons after applying the first beam to the first end of the path has the effect of increasing the potential of the second end of the path, so that the electrons collected vertically to the second beam are less numerous, for equal energy of the laser. The difference ΔQ also depends on the resistance of the conducting pad between its contact pads, the resistance slowing the propagation of electrons between two test points. The higher the resistance is, the lower the transfer speed of electrons is and consequently, the more the electric potential of the second end increases slowly during the first shot. Thus, the electrons collected after applying the second beam of light are all the more numerous since the resistance is high. Eventually, the difference ΔQ also depends on the capacitance of the conducting path.

A practical example of implementation of the second variation of the method of the invention is now going to be described.

The potential of the conducting path 2-1 is firstly set to a value of potential lower than the one of the collector, which depends on the value of the capacitance of the path. For example, the path can be put to the ground. This setting, which corresponds to a resetting step, can be obtained using conventional means (for example a carbon brush) or using a “photoelectric effect by reflection”; that is applying to the collector a reflected beam of light coming from the incident beam of light applied to the target area (i.e. the test point, or here the contact pads). The process is performed in presence of a collector voltage substantially equal to zero. Thus, electrons are extracted from the collector by the reflected beam of light and go to the target area causing its electric potential to decrease until it is equal to the potential of the collector.

The beam of light 4-1 is then applied to the pad 3-1. The electrons liberated by photoelectric effect are collected by the collector and the quantity of electricity Q1 is measured.

The second beam of light 4-2 is then applied to the pad 3-2, with the temporal shift Δt, and the quantity of electricity Q₂ is measured.

The capacitance of the path at the level of the pad 3-1 of the path being referred to as C₁ and the capacitance of the path at the level of the pad 3-2 being referred to as C₂, it appears that the difference of electric potential at the terminals of the capacitance C₁ increases and electrons coming from the capacitance C₂ go through the resistance R₀ of the path when the first beam of light is applied. If the path has a low resistance, the capacitances are practically in parallel and the charge of the capacitance C₁ immediately triggers the charge of C₂.

However, if the path has a higher resistance, the electrons slowly go from one capacitance to the other.

For the same energy as the energy of the first beam of laser light and the same electric potential of collector, the collected quantity of charges Q₂ should be lower since a part of the charge of the second pad has in principle reached the first pad. If the conducting path is totally charged (taken to the voltage Vc of the collector) after the two laser shots, the total collected quantity of charges Q is equal to Q₁+Q₂=CVc, that is the quantity of charges which would have been collected on one of the two pads if one single beam had been applied on the path, with the view of completely charging it. The total collected quantity of charges equally coming from the capacitance C₁ or the capacitance C₂ is given by the formula: Q=(C₁+C₂)×E, where E is the initial difference of potential between the collector and the path. However, the distribution of the electrons collected via the contact pads of the path varies with the respective values of the capacitances (in general identical for the paths having a symmetry in relation to the plane of the collector), the delay between the two light pulses, and especially the value of the resistance R₀.

If the resistance R₀ is low, the capacitances simultaneously charge during the application of the first beam of laser light to the pad 3-1, so that no electron move during the second shot. Therefore, in this case, Q₁=Q and Q₂=0.

However, if the resistance R₀ is infinite, which particularly corresponds to a faulty path, the charge collected during the application of the first shot is Q₁=C₁×E, whereas the charge collected during the application of the second beam is Q₂=C₂×E. In this last case, it is possible to locate the fault of the path, since the ratio of collected charges gives the ratio of the distance between the contact pads of the path and the point where the fault is located.

It is worth noting that the total collected quantity of charges Q is always the same but its distribution varies with the value of the resistance R₀=(ΔQ, Δt, E).

However, it is there again reminded that it is not necessary to completely charge the path after the laser light shots. Thus, if the charge Q₁ collected at the first end of the conducting path and the total capacitance of this path are known, it is possible to calculate the law of evolution according to time of the charge collected at the level of the pad 3-2. After a time Δt, a quantity of charge Q₂ is measured, if the second laser pulse is the same as the first, which must be equal to Q₁ minus the quantity of charges which has moved and which depends on R₀, C₁ and C₂.

Numerical calculations described hereinafter are used to provide the distribution of quantities of charges according to the different parameters of the system, according to the capacitances C₁, C₂ of the electric potential of the collector, the pulse duration and luminous intensity, and the resistance R₀. These calculations refer to FIGS. 2A, 2B which respectively show the equivalent diagram of the system during the application of the beam of laser light to the first pad 3-1, and the equivalent diagram of the system during the application of the beam of laser light to the first pad 3-2. These Figs. show the following parameters/variables:

R₀: resistance to be measured of the path 2-1 between the pads 3-1, 3-2;

E: voltage of the equivalent generator applied to the collector 5;

C₁: capacitance of the first end of the path (pad 3-1);

C₂: capacitance of the second end of the path (pad 3-2);

i₀: current flowing through the path 2-1 of resistance R₀;

V₁(t): potential at the terminals of C₁;

V₂(t): potential at the terminals of C₂;

−R₁(t): resistance modelling the photoelectric effect on the pad 3-1; and

−R₂(t): resistance modelling the photoelectric effect on the pad 3-2.

Regarding the resistances R₁(t) and R₂(t), the photoelectric effect is indeed modelled by a simple law according to which it is assumed that the current between the pad receiving the photoelectric impact and the collector is proportional to the difference of potential between the collector and the pad. The current/voltage proportionality coefficient depends on the level of instantaneous illuminance of the pad. Regarding the pad 3-1, this coefficient is likened, in the following calculations, to a resistance R₁(t) shown in FIG. 2A, receiving the voltage E on its anode, its cathode being connected to the pad 3-1 and being crossed by a current i₁. Regarding the pad 3-2, this coefficient is likened to a resistance R₂(t) receiving the voltage E on its anode, its cathode being connected to the pad 3-2 and being crossed by a current i₂. With reference to FIG. 2A, the following can be written:

$$\begin{matrix}{V}_{2} = \frac{1}{{C}_{2}} \int {i}_{0} ⅆ t i . e . {i}_{0} = {C}_{2} \frac{\partial {V}_{2}}{\partial t} , & ( 1 ) \\ {V}_{1} = {R}_{0} {i}_{0} + {V}_{2} i . e . \frac{\partial {V}_{1}}{\partial t} = {R}_{0} \frac{\partial {i}_{0}}{\partial t} + \frac{\partial {V}_{2}}{\partial t} = {R}_{0} \frac{\partial {i}_{0}}{\partial t} + \frac{{i}_{0}}{{C}_{2}} , \\ and \\ E = {R}_{1} {i}_{1} + {V}_{1} & ( 2 ) \\ \text{As:} \frac{\partial E}{\partial t} = 0 = {R}_{1} \frac{\partial {i}_{1}}{\partial t} + \frac{\partial {V}_{1}}{\partial t} & ( 3 )\end{matrix}$$

It is also possible to write:

$${C}_{1} \frac{\partial {V}_{1}}{\partial t} = {i}_{1} - {i}_{0} \qquad ( 4 )$$

Then transferring the relation (3) in the relation (4):

$$- {R}_{1} {C}_{1} \frac{\partial {i}_{1}}{\partial t} = {i}_{1} - {i}_{0} \qquad ( 5 )$$

Transferring the relation (3) in the relation (2) and showing the term i₁−i₀ in the left part:

$${R}_{0} \frac{\partial ( {i}_{0} - {i}_{1} )}{\partial t} + \frac{{i}_{0} - {i}_{1}}{{C}_{2}} = - {R}_{0} \frac{\partial {i}_{1}}{\partial t} - {R}_{1} \frac{\partial {i}_{1}}{\partial t} - \frac{{i}_{1}}{{C}_{2}}$$

Using the relation (5), the following is obtained:

$${R}_{0} \frac{\partial ( {i}_{0} - {i}_{1} )}{\partial t} + \frac{{i}_{0} + {i}_{1}}{{C}_{2}} + \frac{( {R}_{0} + {R}_{1} )}{{R}_{1} {C}_{1}} ( {i}_{0} - {i}_{1} ) = - \frac{{i}_{1}}{{C}_{2}}$$

which, after derivation, results in the following:

$${R}_{0} \frac{{\partial }^{2} ( {i}_{0} - {i}_{1} )}{\partial {t}^{2}} + [ \frac{( {R}_{0} + {R}_{1} )}{{R}_{1} {C}_{1}} + \frac{1}{{C}_{2}} ] \frac{\partial ( {i}_{0} - {i}_{1} )}{\partial t} = - \frac{\partial {i}_{1}}{{C}_{2} \partial t}$$

Using the relation (5) again, the following is obtained:

$${R}_{0} \frac{{\partial }^{2} ( {i}_{0} - {i}_{1} )}{\partial {t}^{2}} + [ \frac{( {R}_{0} + {R}_{1} )}{{R}_{1} {C}_{1}} + \frac{1}{{C}_{2}} ] \frac{\partial ( {i}_{0} - {i}_{1} )}{\partial t} + \frac{( {i}_{0} - {i}_{1 )}}{{C}_{2} {C}_{1} {R}_{1}} = 0$$

which is of the form:

$$A \frac{{\partial }^{2} f}{\partial {t}^{2}} + B \frac{\partial f}{\partial t} + C = 0$$

and which solution is:

$$f = U {ⅇ}^{α t}$$

$$\text{where:}$$

$$α = \frac{- B \pm \sqrt{{B}^{2} - 4 A C}}{2 A} .$$

If this solution is transferred in the relation (5), the following is obtained:

$${V}_{1} = \frac{1}{{C}_{1}} \int {i}_{1} - {i}_{0} + c t e , \\ \text{i.e.:}$$

$${V}_{1} = \frac{U}{α {C}_{1}} {ⅇ}^{α t} + c t e$$

At an instant t=0, the voltage V₁ is equal to zero and when t tends toward infinity, this voltage V₁ is equal to the voltage of the collector. Therefore:
V₁=(−e^{αt} +1)E

Using the relation (3), the following is equally obtained:

$${i}_{1} = {e}^{α t} \frac{E}{{R}_{1}}$$

In order to be able to take into account an arbitrary form of R₁(t), it is necessary to go over the calculation procedure as described below.

Considering the part of the circuit of FIG. 2A formed by the resistance R₀, the second pad 3-1 and the capacitance C₂, the whole being subjected to the voltages V1 and V2, the following is obtained:
V₁Aδ(t)

where δ(t) is the Dirac distribution.

The response to the short but intense pulse of the beam is a charge δq instantaneously injected such that:

$$δ q = {\int }_{- ∞}^{+ ∞} \frac{{V}_{1}}{{R}_{0}} ⅆ t = \frac{A}{{R}_{0}} {\int }_{- ∞}^{+ ∞} δ ( t ) ⅆ t = \frac{A}{{R}_{0}}$$

Considering a voltage V₂ caused by an instantaneous density of charges δq/δt corresponding to the injected charge δq. The following is obtained:

$${C}_{2} {V}_{2} = \frac{A}{{R}_{0}}$$

The charge δq then disappears by the discharge of the circuit. Therefore:

$${V}_{2} ( t ) = \frac{A}{{C}_{2} {R}_{0}} {ⅇ}^{- \frac{t}{{C}_{2} {R}_{0}}}$$

The response to any voltage variable with time is therefore given by the convolution of V₁(t) by the pulse response with A=1.

$${V}_{2} ( t ) = {\int }_{0}^{t} \frac{{V}_{1} ( {t}_{0} )}{{C}_{2} {R}_{0}} {ⅇ}^{- \frac{t - {t}_{0}}{{C}_{2} {R}_{0}}} ⅆ {t}_{0}$$

This value of V₂ can therefore be used in the diagram of FIG. 2A which is considered comprehensive (with all the elements shown), and which equation is:

$${C}_{1} \frac{\partial {V}_{1}}{\partial t} = {i}_{1} - {i}_{0} = \frac{E - {V}_{1}}{{R}_{1} ( t )} - \frac{{V}_{1} - {V}_{2}}{{R}_{0}}$$

$$i . e . : \\ {C}_{1} \frac{\partial {V}_{1}}{\partial t} = \frac{E - {V}_{1}}{{R}_{1} ( t )} - \frac{{V}_{1} - {\int }_{0}^{t} \frac{{V}_{1} ( {t}_{0} )}{{C}_{2} {R}_{0}} {ⅇ}^{- \frac{t - {t}_{0}}{{C}_{2} {R}_{0}}} ⅆ {t}_{0}}{{R}_{0}} .$$

In this form, the equation is integrable using a simple numerical program. Indeed, V₁=0 and V₂=0 are just taken as initial values to obtain:

$${V}_{1} ( t + Δ t ) \approx {V}_{1} + [ \frac{E - {V}_{1} ( t )}{{C}_{1} {R}_{1} ( t )} - \frac{{V}_{1} ( t ) - {V}_{2} ( t )}{{C}_{1} {R}_{0}} ] Δ t$$

$$\begin{matrix}{V}_{2} ( t + Δ t ) = {\int }_{0}^{t} \frac{{V}_{1} ( {t}_{0} )}{{C}_{2} {R}_{0}} {ⅇ}^{- \frac{t + Δ t - {t}_{0}}{{C}_{2} {R}_{0}}} ⅆ {t}_{0} + \\ {\int }_{t}^{t + Δ t} \frac{{V}_{1} ( {t}_{0} )}{{C}_{2} {R}_{0}} {ⅇ}^{- \frac{t + Δ t - {t}_{0}}{{C}_{2} {R}_{0}}} ⅆ {t}_{0} \\ \approx {V}_{2} ( t ) {ⅇ}^{- \frac{Δ t}{{C}_{2} {R}_{0}}} + \frac{{V}_{1} ( t )}{{C}_{2} {R}_{0}} Δ t\end{matrix}$$

$$or \text{:}$$

$${V}_{1} ( t + Δ t ) \approx {V}_{1} + [ \frac{E - {V}_{1} ( t )}{{C}_{1} {R}_{1} ( t )} - \frac{{V}_{1} ( t ) - {V}_{2} ( t )}{{C}_{1} {R}_{0}} ] * Δ t$$

$${V}_{2} ( t + Δ t ) \approx {V}_{2} ( t ) * {ⅇ}^{\frac{Δ t}{{C}_{2} {R}_{0}}} + \frac{{V}_{1} ( t )}{{C}_{2} {R}_{0}} Δ t$$

The right members only depend on known terms. It is a recurrent presentation showing what happens at the instant t+Δt when the values are known at the instant t.

In addition, with reference to FIG. 2B, it is also possible to write:

$${C}_{1} \frac{\partial {V}_{1}}{\partial t} = {i}_{1} - {i}_{0} = \frac{E - {V}_{1}}{{R}_{1} ( t )} - \frac{{V}_{1} - {V}_{2}}{{R}_{0 }}$$

$$and$$

$${C}_{2} \frac{\partial {V}_{2}}{\partial t} = {i}_{2} - {i}_{0} = \frac{E - {V}_{2}}{{R}_{2} ( t )} + \frac{{V}_{1} - {V}_{2}}{{R}_{0}}$$

The discretization of these equations leads to:

$${V}_{1} ( t + Δ t ) = {V}_{1} ( t ) + ( \frac{E - {V}_{1} ( t )}{{C}_{1} {R}_{1} ( t )} - \frac{{V}_{1} ( t ) - {V}_{2} ( t )}{{C}_{1} {R}_{0 }} ) * Δ t$$

$$and$$

$${V}_{2} ( t + Δ t ) = {V}_{2} ( t ) + ( \frac{E - {V}_{2} ( t )}{{C}_{2} {R}_{2} ( t )} + \frac{{V}_{1} ( t ) - {V}_{2} ( t )}{{C}_{2} {R}_{0}} ) * Δ t .$$

The initial values of V₁ and V₂ are fixed at 0 since the potential of the path is reset to 0 as suggested above (for example using a photoelectric effect by reflection).

The following parameters are considered by way of illustration:

E=60 V,

C₁=C₂=1 pF,

substrate/collector distance=10 μm,

beam of light diameter=80 μm,

laser energy=10 μJ,

pulse duration=4 ns,

temporal shift Δt=4 ns,

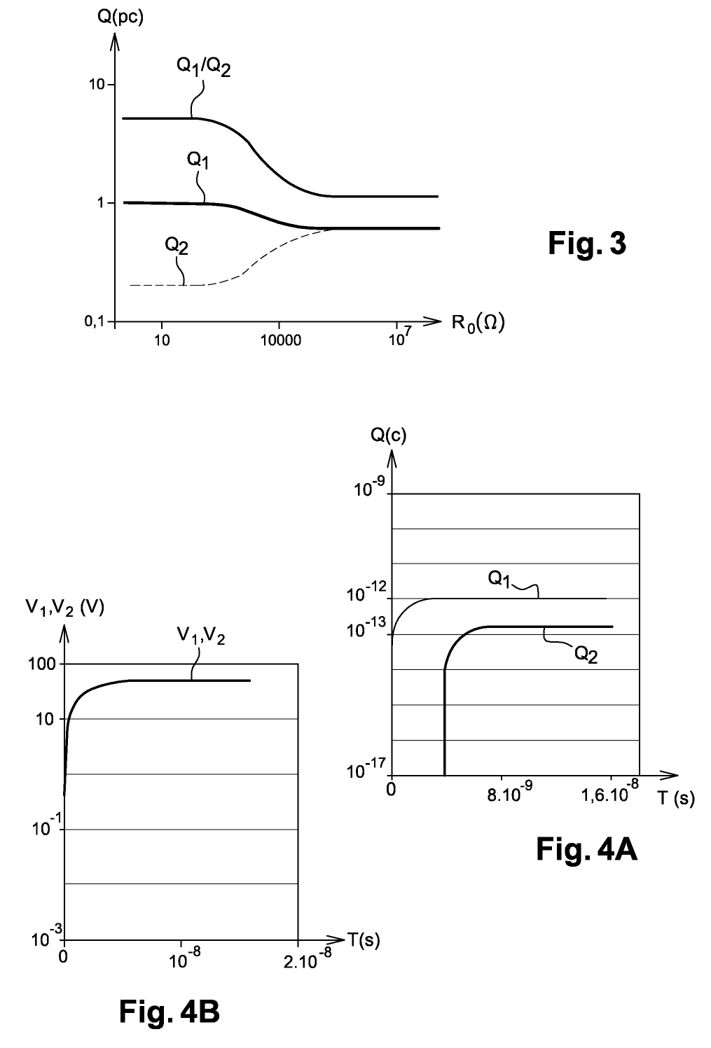

With these parameters, the curves Q₁, Q₂ and Q₁/Q₂ shown on the graph of FIG. 3 are obtained. These curves illustrate the variation in pico-Coulombs (pC) of the collected charges, and the variation ratio Q₁/Q₂ according to the resistance R₀ of the path expressed in Ohms (abscissa axis). The following values in particular are observed:

R₀=1000 MΩ: Q₁/Q₂=1 and Q₁=Q₂=0.569 pC

R₀=100 MΩ: Q₁/Q₂=1 and Q₁=Q₂=0.569 pC

R₀=10 MΩ: Q₁/Q₂=1.001, Q₁=0.570 pC and Q₂=0.569 pC

R₀=1 MΩ: Q₁/Q₂=1.005, Q₁=0.570 pC and Q₂=0.567 pC

R₀=100 KΩ: Q₁/Q₂=1.053, Q₁=0.578 pC and Q₂=0.549 pC

R₀=10 KΩ: Q₁/Q₂=1.531, Q₁=0.649 pC and Q₂=0.424 pC

R₀=1 KΩ: Q₁/Q₂=3.705, Q₁=0.837 pC and Q₂=0.234 pC

R₀=100Q: Q₁/Q₂=4.763, Q₁=0.938 pC and Q₂=0.197 pC

R₀=10Q: Q₁/Q₂=4.894, Q₁=0.946 pC and Q₂=0.193 pC

R₀=2Q: Q₁/Q₂=4.906, Q₁=0.946 pC and Q₂=0.193 pC

Thus, the values of Q₁ and Q₂ and the ratio Q₁/Q₂ are representative of the resistance R₀. In the chosen example, the ratio Q₁/Q₂ does not allow several values of R₀ when R₀ has a very high value to be differentiated, because the temporal shift in all cases is inferior to the propagation time of the electrons (the RC constant being very important). The method, for a given temporal shift, therefore offers a great precision for small values of R₀, which is an important advantage in relation to the conventional testing methods. The lower is the temporal shift between the two ejections of electrons, the more precise is the measure of a low resistance.

FIGS. 4A, 4B respectively represent the evolution with time of the charges Q1, Q2 collected on the pads 3-1, 3-2 at each end of the conducting path all through the duration of the laser light shot and the corresponding evolution with time of the voltages V1(t) and V2(t) at the terminals of the capacitances C₁ and C₂, for R₀=2 Ω, Q₁=0.946 pC and Q₂=0.193 pC (Q₁/Q₂=4.906). The collected charges are expressed in Coulombs on the ordinate axis of FIG. 4A, the voltages V1(t), V2(t) are in Volts on the ordinate axis of FIG. 4B the time is expressed in seconds on the abscissa axis of both Figs. In FIG. 4B, the curves of the voltages V₁(t) and V₂(t) are identical. They tend to a tangent which is equal to the voltage Vc of the collector. However, when the paths have high capacitances with regard to the energy of the pulse of the beam of laser light, the latter does not totally charge the capacitances, and the final voltages V1, V2 after applying the double pulse do not reach the voltage Vc of the collector. They reach a voltage lower than Vc which is nevertheless identical in each test point if the path does not have a fault of continuity.

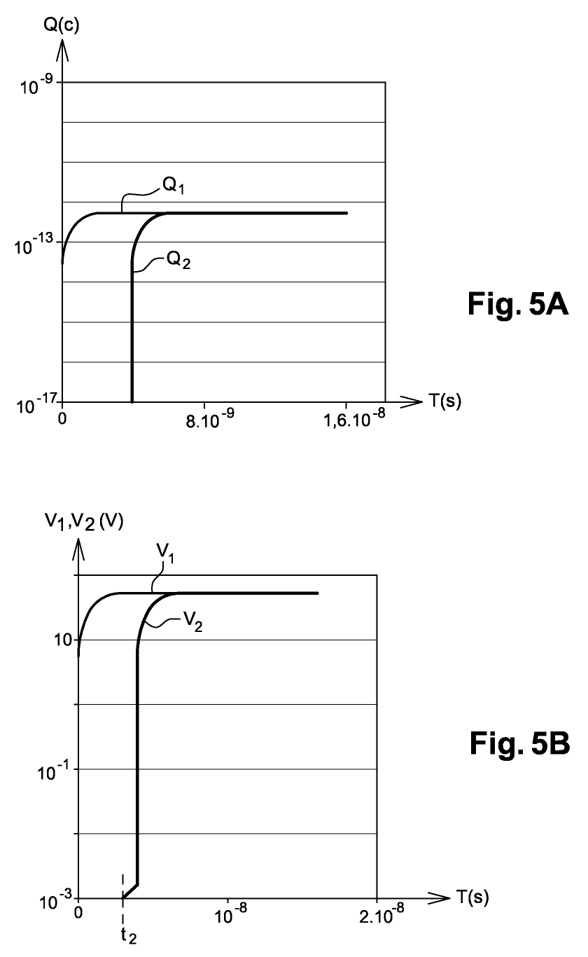

Other curves of evolution of the collected charges Q₁, Q₂ during the shot and of evolution of the voltages V₁, V₂ at the terminals of the capacitances C₁ and C₂ are respectively shown on FIGS. 5A and 5B for R₀=100Ω, Q₁=0.946 pC and Q₂=0.193 pC (Q₁/Q₂=4.906). The collected charges are expressed in Coulombs on the ordinate axis of FIG. 5A, the voltages V1(t), V2(t) are in Volts on the ordinate axis of FIG. 5B, the time is expressed in seconds on the abscissa axis of both Figs.

It appears that the potential V2 at the terminals of C₂ has hardly changed between the instant 0 and the instant t2 of the application of the second pulse, due to the low transfer of electrons between C₁ and C₂ caused by the important value of the resistance R₀. The path thus behaves as if it was split into two. Consequently, the collected charges Q₁ and Q₂ are connected to the capacitances C₁ and C₂, identical if C₁=C₂.

The method described above can be adapted, thanks to routine operations of those skilled in the art, regarding any feature of the element to be tested, according to the electric configuration of this element. In addition, this method can be implemented on all the conducting paths constituting a network of equipotentials in a substrate. The method therefore allows this substrate to be tested.

To determine the insulation of a path compared to another or compared to a set of other paths possibly linked between them, the first location, to which the first beam of particles is applied, is located on a first conducting path and the second location, to which the second beam of particles is applied, is applied to a second conducting path. The two paths, although distinct, form, seen from the two measuring points, an electric element having a serial resistance which corresponds to the resistance of insulation between the paths.

It is preferable, but not compulsory, to know the potential of the path to which the beam of particles is applied (or of the two paths when it is an insulation test), this potential having to be lower than the potential of the collector, so as to allow electrons to be collected. Thus, the path may be previously put to the ground to form the initial reference potential.

A measure of resistance R₀ has been described above according to one embodiment of the invention, applicable to the measure of a serial resistance of a conductor which continuity must be tested or to the measure of the insulation resistance between two conductors. It will be clear to those skilled in the art that the above reasoning regarding the elaboration of a model of calculation applied to the resistance R₀ also applies to other types of elementary electric components like capacitances and self-inductances, using the relations existing in transient state between the features of these components, the current crossing them and the voltage at their terminals.

In general, it has been demonstrated above that the distribution of the charges collected between two test points after applying two beams of particles shifted with time, can be measured and is representative of the electric feature present between the two test points.

Thus, although the description of the present invention relates to the qualitative or quantitative test of conductors and/or resistances by way of example, it clearly appears to those skilled in the art that the invention can be used to test or measure a resistance, a capacitance or a self-inductance or a complex combination of these elements and that consequently, the invention can be applied to any types of electric elements like electric or electronic components, since any electric or electronic component can be modelled by a combination of resistances, capacitances and/or self-inductances.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method for testing or measuring electric elements, the method comprising:
applying a first beam of particles to a first location of an electric element, to liberate electrons from the first location;
applying a second beam of particles to a second location of an electric element with a temporal shift (Δt) different from zero compared to the application of the first beam of particles to the first location, to liberate electrons from the second location, the temporal shift being of the order of magnitude of a propagation time of electrons between the first and the second location;
collecting electrons liberated under the effect of the application of the first beam of particles to the first location;
collecting electrons liberated under the effect of the application of the second beam of particles to the second location; and
measuring at least one quantity of electric charges corresponding to the collected electrons liberated under the effect of the application of the second beam of particles to the second location, and quantitatively or qualitatively deducing therefrom an electric feature of the electric element.

2. The method according to claim 1, wherein the temporal shift (Δt) is of about one pico-second to a plurality of nano-seconds.

3. The method according to claim 1, wherein at least one of the insulation, the continuity, the capacitance and the resistance of the electric element is deduced from the comparison of the quantity of electric charges collected under the effect of the application of the first beam of particles to the quantity of electric charges collected under the effect of the application of the second beam of particles.

4. The method according to claim 1, wherein the electric element is one of an electric conductor, a group of electric conductors, an electric component, and an electronic component.

5. The method according to claim 1, wherein the first location is a first pad of an electric conductor and the second location is one of a second pad of the electric conductor and a pad of another electric conductor.

6. The method according to claim 1, wherein the first and the second beams of particles are beams of ultraviolet light.

7. The method according to claim 1, wherein the first and the second beams of particles result from the division of a same beam of particles.

8. The method according to claim 1, wherein the temporal shift (Δt) is obtained by making the second beam of particles travel a greater distance than the distance of the first beam of particles, before the second beam of particles reaches the second location.

9. The method according to claim 1, wherein the electrons liberated under the effect of the application of the first and second beams of particles are collected by a collector taken to an electric potential (Vc), and wherein at least the first location is taken to a potential lower than the potential of the collector prior to the application of the first beam of particles to the first location.

10. The method according to claim 1, wherein the electrons liberated under the effect of the application of the first and second beams of particles are collected by a collector taken to an electric potential (Vc), the application of the first beam of particles takes the electric element to the potential (Vc) of the collector and the quantity of electric charges collected under the effect of the application of the second beam of particles is measured.

11. The method according to claim 1, wherein the electrons liberated under the effect of the application of the first and second beams of particles are collected by a collector, and wherein the collector comprises at least a first collecting electrode facing the first location and at least a second collecting electrode facing the second location, both the first and second collecting electrodes being distinct and individually accessible to take a local measure of collected electric charge.

12. A method for manufacturing an interconnection support or an electronic circuit arranged on an interconnection support, the interconnection support or the electronic circuit comprising electric elements, the method comprising a step for testing or measuring all or part of the electric elements of the interconnection support or of the electronic circuit, the step for testing or measuring all or part of the electric elements of the interconnection support or of the electronic circuit comprising:
applying a first beam of particles to a first location of an electric element, to liberate electrons from the first location;
applying a second beam of particles to a second location of an electric element with a temporal shift (Δt) different from zero compared to the application of the first beam of particles to the first location, to liberate electrons from the second location, the temporal shift being of the order of magnitude of a propagation time of electrons between the first and the second location;
collecting electrons liberated under the effect of the application of the first beam of particles to the first location;
collecting electrons liberated under the effect of the application of the second beam of particles to the second location; and
measuring at least one quantity of electric charges corresponding to the collected electrons liberated under the effect of the application of the second beam of particles to the second location, and quantitatively or qualitatively deducing therefrom an electric feature of the electric element.

13. The method according to claim 12, wherein the temporal shift (Δt) is of about one pico-second to a plurality of nano-seconds.

14. The method according to claim 12, wherein at least one of the insulation, the continuity, the capacitance and the resistance of the electric element is deduced from the comparison of the quantity of electric charges collected under the effect of the application of the first beam of particles to the quantity of electric charges collected under the effect of the application of the second beam of particles.

15. The method according to claim 12, wherein the electric element is one of an electric conductor, a group of electric conductors, an electric component, and an electronic component.

16. The method according to claim 12, wherein the first location is a first pad of an electric conductor and the second location is one of a second pad of the electric conductor and a pad of another electric conductor.

17. The method according to claim 12, wherein the first and the second beams of particles are beams of ultraviolet light.

18. The method according to claim 12, wherein the first and the second beams of particles result from the division of a same beam of particles.

19. The method according to claim 12, wherein the temporal shift (Δt) is obtained by making the second beam of particles travel a greater distance than the distance of the first beam of particles, before the second beam of particles reaches the second location.

20. The method according to claim 12, wherein the electrons liberated under the effect of the application of the first and second beams of particles are collected by a collector taken to an electric potential (Vc), and wherein at least the first location is taken to a potential lower than the potential of the collector prior to the application of the first beam of particles to the first location.

21. The method according to claim 12, wherein the electrons liberated under the effect of the application of the first and second beams of particles are collected by a collector taken to an electric potential (Vc), the application of the first beam of particles takes the electric element to the potential (Vc) of the collector and the quantity of electric charges collected under the effect of the application of the second beam of particles is measured.

22. The method according to claim 12, wherein the electrons liberated under the effect of the application of the first and second beams of particles are collected by a collector, and wherein the collector comprises at least a first collecting electrode facing the first location and at least a second collecting electrode facing the second location, both the first and second collecting electrodes being distinct and individually accessible to take a local measure of collected electric charge.

23. A system for testing or measuring electric elements, the system comprising:
an applying device for applying a first beam of particles to a first location of an electric element so as to induce a liberation of electrons from this first location and applying a second beam of particles to a second location of an electric element so as to induce a liberation of electrons from the second location;
a shifting device for shifting the application of the second beam of particles to the second location compared to the application of the first beam of particles to the first location, with a temporal shift (Δt) different from zero, the temporal shift being of the order of magnitude of a propagation time of electrons between the first and the second location;
at least one collector for collecting electrons liberated under the effect of the application of the first beam of particles and electrons liberated under the effect of the second beam of particles; and
a measuring device for measuring at least one quantity of electric charges corresponding to the collected electrons liberated under the effect of the application of the second beam of particles to the second location, and quantitatively or qualitatively deducing therefrom an electric feature of the electric element.

24. The system according to claim 23, wherein the temporal shift (Δt) is of about one pico-second to some nano-seconds.

25. The system according to claim 23, wherein the collector comprises at least one first collecting electrode facing the first location and at least one second collecting electrode facing the second location, both collecting electrodes being distinct and individually accessible, and allowing the measuring means to take a local measure of collected electric charge, at least at the second location.

26. The system according to claim 23, further comprising: a deducing device for deducing the continuity, insulation, capacitance and/or resistance of the electric element from a measure of the quantity of electric charges collected under the effect of the application of the first beam of particles and the quantity of electric charges collected under the effect of the application of the second beam of particles.

27. The system according to claim 23, arranged for testing or measuring an electric conductor or a group of electric conductors, an electric component or an electronic component.

28. The system according to claim 23, comprising a dividing device for dividing a beam of particles in order to form the first and the second beams of particles.

29. The system according to claim 23, comprising a delay device for having the second beam of particles travel a greater distance than the distance of the first beam of particles, before the second beam of particles reaches the second location of the electric element.

30. The system according to claim 23, wherein the first and second beams of particles are beams of ultraviolet light.

31. The system according to claim 23, comprising a beam splitter fitted with holes arranged between the substrate and the collector, the holes forming flow channels for electrons.

32. They system according to claim 23, comprising a collector that includes several electrodes and a repulsive potential device that takes electrodes to a repulsive potential in order to form flow channels for electrons.
